(19) United States
(12) Patent Application Publication
(10) Pub. No.: US 2015/0240991 A1
(43) Pub. Date: Aug. 27, 2015

(54) CORNER HANGING SYSTEM

(71) Applicant: Frank Gallo, Canton, GA (US)

(72) Inventor: Frank Gallo, Canton, GA (US)

(21) Appl. No.: 14/188,639

(22) Filed: Feb. 24, 2014

(51) Int. Cl. F16M 13/02; F16B 45/00

(52) U.S. Cl. CPC F16M 13/025; F16M 13/02; F16B 45/00

(57) ABSTRACT

A combined hinge pin hanging device, for hanging items at inside corners, at outside corners, and on flat wall surfaces includes: a first member, elongated, straight, generally cylindrical, and of a predetermined length, consisting of a continuous first diameter, for placement securely within an axial continuous passage formed collectively within knuckles of interleaved hinge leaves, thereby to secure as a hinge pin; a second member, elongated, generally cylindrical, and not continuously straight, of a second diameter, the first and second members coupled, and the second member extending upwardly from a top of the first member, the second member also consisting of at least one portion that extends outwardly away from an axial line of the first member upon which to hang an item; and a stop defined between the first and second members to prevent the device from entry beyond the stop into the axial continuous passage.

### FIELD OF THE INVENTION

The technology described herein relates generally to the fields of mounting hardware and hanging devices such as hinges, hanging brackets, corner brackets, and so forth. More specifically, this technology relates to a hinge-based hanging system for hanging items on walls, or like surfaces, and more particularly for hanging these items selectively at inside corners between walls, at outside corners of adjacent walls, and on flat wall surfaces. Furthermore, this technology relates to a combined hinge pin and hanging bracket for use within the hinge-based hanging system.

### BACKGROUND OF THE INVENTION

Certain object-hanging devices and systems are known in the background art that enable one to hang items such as pictures frames, shelving, plants, and so forth from walls and other like surfaces. Corners are known to provide additional difficulties, however. Known devices and systems are inefficient to effectively overcome such difficulties. Others have attempted to overcome these deficiencies with hanging devices having various constructions; however, these devices also have been found to have various shortcomings and deficiencies as well.

Related utility patents known in the art include the following:

U.S. Pat. No. 505,230, issued to Robinson on Sep. 19, 1893, discloses a corner picture hanger.

U.S. Pat. No. 1,219,025, issued to Mertz on Mar. 13, 1917, discloses a bracket.

U.S. Pat. No. 3,578,205, issued to Ballester on May 11, 1971, discloses a corner suspendable pail and hanger.

U.S. Pat. No. 5,094,421, issued to Zaccone on Mar. 10, 1992, discloses a corner hanger.

U.S. Pat. No. 5,154,384 issued to Owens on Oct. 13, 1992, discloses a corner hanger.

U.S. Pat. No. 5,810,317, issued to Macchi on Sep. 22, 1998, discloses a corner hanger arrangement.

U.S. Pat. No. 6,015,123, issued to Perez et al, on Jan. 18, 2000, discloses a mounting bracket for a camera base.

U.S. Pat. No. 6,364,261, issued to Vass, Jr. on Apr. 2, 2002, discloses a corner mounting bracket.

U.S. Pat. No. 7,631,844, issued to Styles on Dec. 15, 2009, discloses a corner potted plant holder.

U.S. Pat. No. 8,215,042, issued to Kilmer on Jul. 10, 2012, discloses a picture hanging device for corners.

U.S. Pat. No. 8,453,982, issued to Baruch on Jun. 4, 2013, discloses a utility corner shelf bracket.

Related U.S. patent application publications known in the art include the following:

U.S. Patent Application Publication No. 2002/0011546, filed by Smith and published on Jan. 31, 2002, discloses an apparatus for supporting and displaying a plant.

Related design patents known in the art include the following:

U.S. Pat. No. Des. 279,641, issued to Elliott on Jul. 16, 1985, discloses the ornamental design for a wall bracket.

U.S. Pat. No. Des. 393,159, issued to Richards et al. on Apr. 7, 1998, discloses the ornamental design for an adjustable plant holder.

U.S. Pat. No. Des. 419,810, issued to John on Feb. 1, 2000, discloses the ornamental design for a wall mounted plant holder.

U.S. Pat. No. Des. 468,553, issued to Nunes on Jan. 14, 2003, discloses the ornamental design for a plant holder.

The foregoing patent information reflects the state of the art of which the inventor is aware and are tendered with a view toward discharging the inventor's acknowledged duty of candor in disclosing information that may be pertinent to the patentability of the technology described herein. It is respectfully stipulated, however, that the foregoing patent and other information do not teach or render obvious, singly or when considered in combination, the inventor's claimed invention.

### BRIEF SUMMARY OF THE INVENTION

In various exemplary embodiments, the technology described herein provides a hinge-based hanging system for hanging items on walls, or like surfaces, and more particularly for hanging these items selectively at inside corners between walls, at outside corners of adjacent walls, and on flat wall surfaces. Furthermore, this technology provides a combined hinge pin and hanging bracket for use within the hinge-based hanging system.

In one exemplary embodiment, the technology described herein provides a combined hinge pin and hanging device, for hanging items selectively on walls at inside corners between walls, at outside corners of adjacent walls, and on flat wall surfaces. The combined hinge pin and hanging device includes: a first member, elongated, straight, generally cylindrical, and of a predetermined length, and consisting of a continuous first diameter for the predetermined length, for placement securely within an axial continuous passage formed collectively within first knuckles of a first hinge leaf and second knuckles of a second hinge leaf, the second hinge leaf interleaved with the first hinge leaf, thereby to secure the first hinge leaf and the second hinge leaf one to another as a hinge pin; a second member, elongated, generally cylindrical, and not continuously straight, and consisting of a second diameter, the second member and the first member coupled one to another and the second member extending upwardly from a top of the first member, the second member also consisting of at least one portion that extends outwardly away from an axial line of the first member upon which to hang an item; and a stop defined between the first member and the second member to prevent the combined hinge pin and hanging device from entry beyond the stop into the axial continuous passage formed collectively within first knuckles of a first hinge leaf and second knuckles of a second hinge leaf, the stop to rest upon a top surface of an uppermost hinge knuckle.

In at least one embodiment, the combined hinge pin and hanging device also includes a curve defined within the second member to position a distal end of the second member away from a mount surface upon which the first hinge leaf and the second hinge leaf are mounted.

In at least one embodiment, the combined hinge pin and hanging device further includes a hook integrally formed with the second member and at a distal end of the combined hinge pin and hanging device.

In at least one embodiment, the combined hinge pin and hanging device also includes a recess formed within the hook to receive an item suspended and hold it securely within the hook.

In at least one embodiment of the combined hinge pin and hanging device, the second diameter of the second member is greater than the first diameter of the first member.

In at least one embodiment of the combined hinge pin and hanging device, the second diameter of the second member is the same as the first diameter of the first member, the stop defined between the first member and the second member having a diameter greater than both of the first member and second member.

In at least one embodiment of the combined hinge pin and hanging device, the first member, the second member, and the stop are integrally formed.

In at least one embodiment of the combined hinge pin and hanging device, the first member and the second member are metal.

In at least one embodiment of the combined hinge pin and hanging device, the first member and the second member are plastic.

In at least one embodiment of the combined hinge pin and hanging device, the first member and is metal and the second member is plastic.

In another exemplary embodiment, the technology described herein provides a hinge-based hanging system hanging items on walls, at inside corners between walls, at outside corners of adjacent walls, and on flat wall surfaces. The hinge-based hanging system includes: a first hinge leaf; a second hinge leaf; a plurality of first knuckles disposed upon the first hinge leaf; a plurality of second knuckles disposed upon the second hinge leaf; an axial continuous passage formed collectively within the first knuckles of the first hinge leaf and the second knuckles of the second hinge leaf, the second hinge leaf interleaved with the first hinge leaf; and a combined hinge pin and hanging bracket comprising: a first member, elongated, straight, generally cylindrical, and of a predetermined length, and consisting of a continuous first diameter for the predetermined length, for placement securely within an axial continuous passage formed collectively within first knuckles of a first hinge leaf and second knuckles of a second hinge leaf, the second hinge leaf interleaved with the first hinge leaf, thereby to secure the first hinge leaf and the second hinge leaf one to another as a hinge pin; a second member, elongated, generally cylindrical, and not continuously straight, and consisting of a second diameter, the second member and the first member coupled one to another and the second member extending upwardly from a top of the first member, the second member also consisting of at least one portion that extends outwardly away from an axial line of the first member upon which to hang an item; and a stop defined between the first member and the second member to prevent the combined hinge pin and hanging device from entry beyond the stop into the axial continuous passage formed collectively within first knuckles of a first hinge leaf and second knuckles of a second hinge leaf, the stop to rest upon a top surface of an uppermost hinge knuckle.

In at least one embodiment, the hinge-based hanging system also includes: a plurality of first recessed apertures defined with the first hinge leaf; a plurality of second recessed apertures defined with the second hinge leaf; and a plurality of mounting screws to thread through the plurality of first recessed apertures and the plurality of second recessed apertures to secure the first hinge leaf and the second hinge leaf to one of an inside corner between walls, an outside corner of adjacent walls, and a flat wall surface.

In at least one embodiment, the hinge-based hanging system further includes a plurality of decorative caps to cover the first recessed apertures and the plurality of second recessed apertures once the mounting screws are inserted and the system is mounted.

In at least one embodiment of the hinge-based hanging system, the first hinge leaf and the second hinge leaf collectively form a circular shape.

In at least one embodiment of the hinge-based hanging system, the first hinge leaf and the second hinge leaf collectively form a decorative, non-square shape.

In at least one embodiment, the hinge-based hanging system also includes a curve defined within the second member of the combined hinge pin and hanging bracket to position a distal end of the second member away from a mount surface upon which the first hinge leaf and the second hinge leaf are mounted.

In at least one embodiment, the hinge-based hanging system further includes a hook integrally formed with the second member of the combined hinge pin and hanging bracket and at a distal end of the of the combined hinge pin and hanging bracket.

In at least one embodiment, the hinge-based hanging system also includes a recess formed within the hook to receive an item hanged and hold it securely within the hook.

In at least one embodiment, the hinge-based hanging system further includes a hanging link to hang upon the hook and with which to couple to an item to be suspended.

In yet another exemplary embodiment, the technology described herein provides a first member, elongated, straight, generally cylindrical, and of a predetermined length, and consisting of a continuous first diameter for the predetermined length, for placement securely within an axial continuous passage formed collectively within first knuckles of a first hinge leaf and second knuckles of a second hinge leaf, the second hinge leaf interleaved with the first hinge leaf, thereby to secure the first hinge leaf and the second hinge leaf one to another as a hinge pin; a second member, elongated, generally cylindrical, and not continuously straight, and consisting of a second diameter, the second member and the first member coupled one to another and the second member extending upwardly from a top of the first member, the second member also consisting of at least one portion that extends outwardly away from an axial line of the first member upon which to hang an item; a stop defined between the first member and the second member to prevent the combined hinge pin and hanging device from entry beyond the stop into the axial continuous passage formed collectively within first knuckles of a first hinge leaf and second knuckles of a second hinge leaf, the stop to rest upon a top surface of an uppermost hinge knuckle; a curve defined within the second member to position a distal end of the second member away from a mount surface upon which the first hinge leaf and the second hinge leaf are mounted; and a hook integrally formed with the second member and at a distal end of the combined hinge pin and hanging device.

Advantageously, the technology described herein provides a hinge-based hanging system for hanging items on walls, or like surfaces, and more particularly for hanging these items selectively at inside corners between walls, at outside corners of adjacent walls, and on flat wall surfaces. Furthermore, this technology provides a combined hinge pin and hanging bracket for use within the hinge-based hanging system.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a front planar view of a hinge for use within a hinge-based hanging system having a combined hinge pin and hanging bracket, illustrating, in particular, a pair of hinge leaves having alternating knuckles, which collectively form a channel to receive a combined hinge pin and hanging bracket for use within the hinge-based hanging system, according to an embodiment of the technology described herein;

FIG. 2 is a front planar view of a hinge for use within a hinge-based hanging system having a combined hinge pin and hanging bracket, according to an embodiment of the technology described herein;

FIG. 3 is a front planar view of a hinge for use within a hinge-based hanging system having a combined hinge pin and hanging bracket, according to an embodiment of the technology described herein;

FIG. 4 is a front planar view of a hinge for use within a hinge-based hanging system having a combined hinge pin and hanging bracket, according to an embodiment of the technology described herein;

FIG. 5 is a front perspective view of a hinge for use within a hinge-based hanging system having a combined hinge pin and hanging bracket, illustrating, in particular, a convex implementation, at an outside corner of adjacent walls, according to an embodiment of the technology described herein;

FIG. 6 is a front perspective view of a hinge for use within a hinge-based hanging system having a combined hinge pin and hanging bracket, illustrating, in particular, a concave implementation, at an inside corner between walls, according to an embodiment of the technology described herein;

FIG. 7 is a front perspective view of a hinge for use within a hinge-based hanging system having a combined hinge pin and hanging bracket, illustrating, in particular, an implementation on a flat wall surface, according to an embodiment of the technology described herein;

FIG. 8 is a front perspective view of a hinge for use within a hinge-based hanging system having a combined hinge pin and hanging bracket, illustrating, in particular, a convex implementation, at an outside corner of adjacent walls, and also illustrating the combined hinge pin and hanging bracket in use as both a hinge and as a hanging bracket for a plant, according to an embodiment of the technology described herein;

FIG. 9 is a top view of a hinge for use within a hinge-based hanging system having a combined hinge pin and hanging bracket, illustrating, in particular, a convex implementation, at an outside corner of adjacent walls, according to an embodiment of the technology described herein;

FIG. 10 is a top view of a hinge for use within a hinge-based hanging system having a combined hinge pin and hanging bracket, illustrating, in particular, a concave implementation, at an inside corner between walls, according to an embodiment of the technology described herein;

FIG. 11 is a top view of a hinge for use within a hinge-based hanging system having a combined hinge pin and hanging bracket, illustrating, in particular, an implementation on a flat wall surface, according to an embodiment of the technology described herein;

FIG. 12 is a side view of a combined hinge pin and hanging bracket, illustrating, in particular, an inner diameter of the combined device that is for insertion into a hinge channel formed collectively by the hinge knuckles, and an outer diameter wide enough to hold the combined device in place in the hinge channel and also configured as a hanging bracket in the upper portion, according to an embodiment of the technology described herein;

FIG. 13 is a side view of a combined hinge pin and hanging bracket, illustrating, in particular, an inner diameter of the combined device that is for insertion into a hinge channel formed collectively by the hinge knuckles, a middle diameter immediately above the hinge wide enough to hold the combined device in place in the hinge channel, and an outer diameter here matching the width of the inner diameter and also configured as a hanging bracket in the upper portion, according to an embodiment of the technology described herein;

FIG. 14 is an expanded view of the hinge for use within a hinge-based hanging system having a combined hinge pin and hanging bracket, illustrating, in particular, mounting hardware and caps to cover the mounting hardware in an aesthetic manner, according to an embodiment of the technology described herein; and

FIG. 15 is a an expanded view of the hinge for use within a hinge-based hanging system having a combined hinge pin and hanging bracket, illustrating, in particular, mounting hardware and caps to cover the mounting hardware in an aesthetic manner, and illustrating the path of insertion for the combined hinge pin and hanging bracket, according to an embodiment of the technology described herein.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides a hinge-based hanging system for hanging items on walls, or like surfaces, and more particularly for hanging these items selectively at inside corners between walls, at outside corners of adjacent walls, and on flat wall surfaces. Furthermore, this technology provides a combined hinge pin and hanging bracket for use within the hinge-based hanging system.

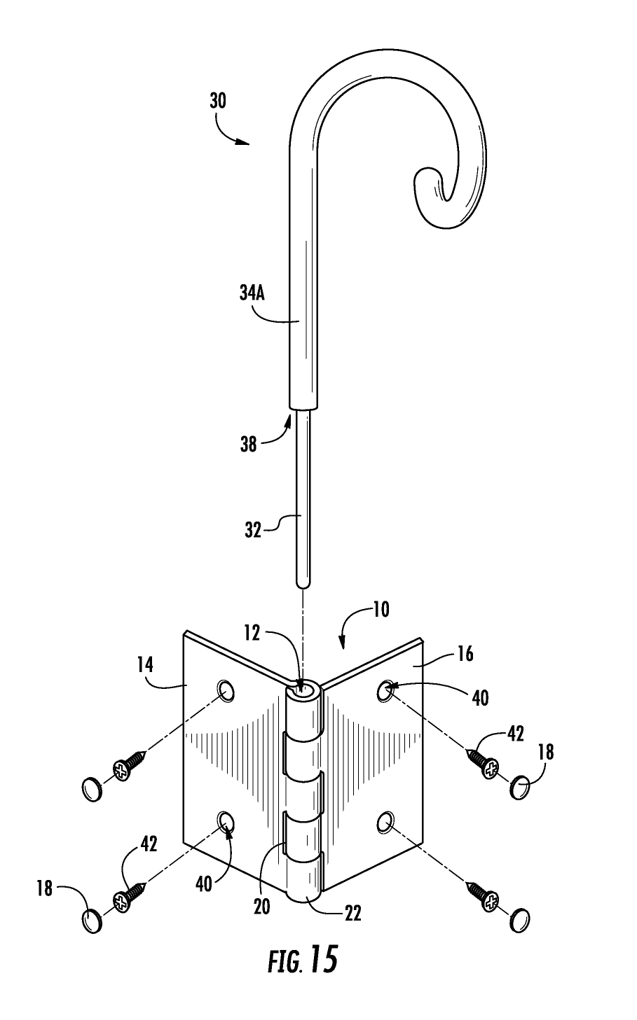

Referring now to the figures, a combined hinge pin and hanging device 30 is shown. The combined hinge pin and hanging device 30 is perhaps best shown in FIGS. 12 and 13. The combined hinge pin and hanging device 30 is used for hanging items selectively on walls at inside corners between walls, at outside corners of adjacent walls, and on flat wall surfaces.

By way of example, and as depicted in FIG. 5, the combined hinge pin and hanging device 30 can be mounted in the axial continuous passage 12 in a hinge assembly 30 on an outside corner of adjacent walls 24, 26, a convex arrangement. This configuration is also depicted in the top, cross-sectional view of FIG. 9 and depicts the axial continuous passage 12 into which the combined hinge pin and hanging device 30 is inserted as shown in FIG. 15.

By way of example, and as depicted in FIG. 6, the combined hinge pin and hanging device 30 can be mounted in the axial continuous passage 12 in a hinge assembly 30 on an inside corner of adjacent walls 24, 26, a concave arrangement. This configuration is also depicted in the top, cross-sectional view of FIG. 10 and depicts the axial continuous passage 12 into which the combined hinge pin and hanging device 30 is inserted as shown in FIG. 15.

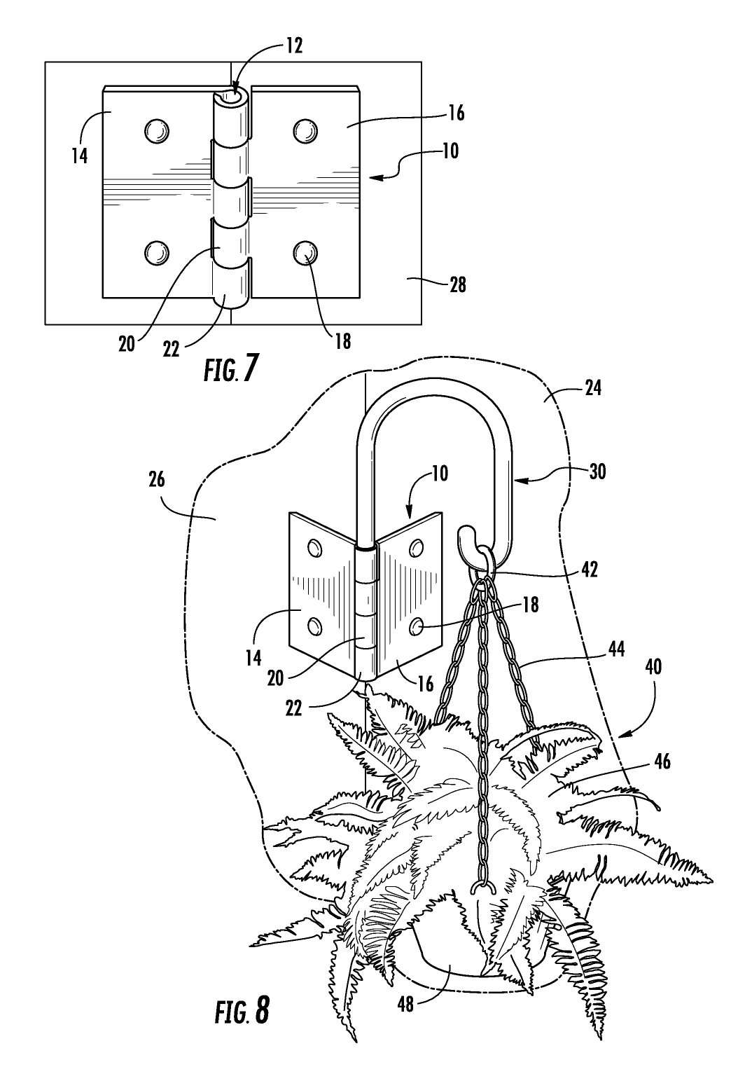

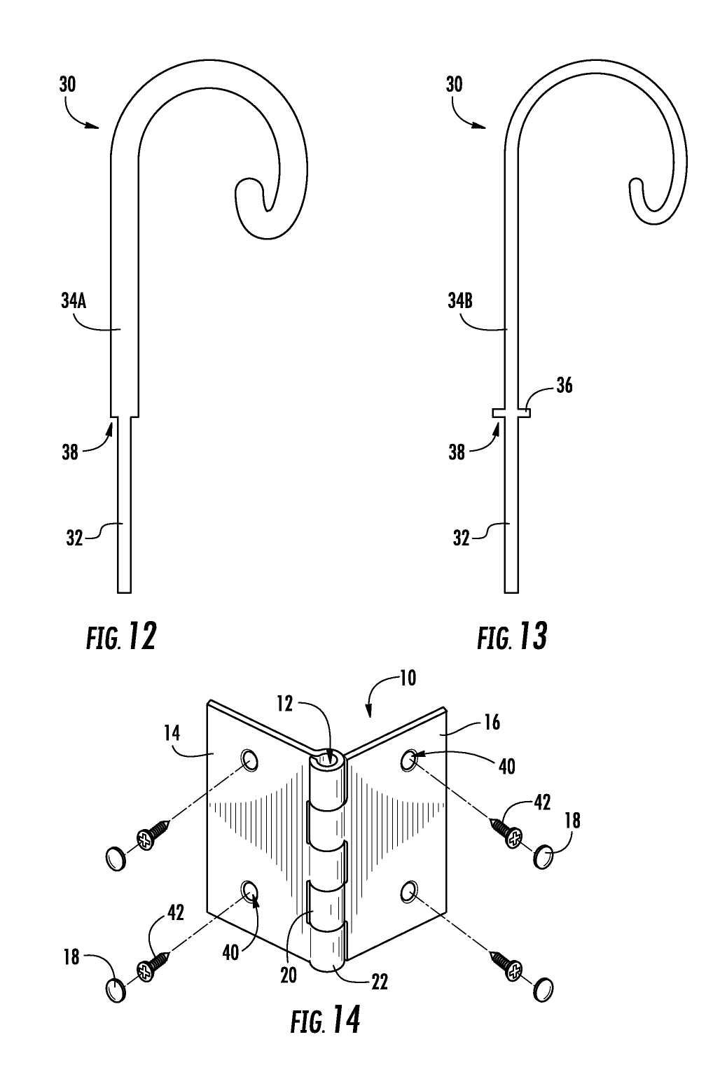

By way of example, and as depicted in FIG. 7, the combined hinge pin and hanging device 30 can be mounted in the axial continuous passage 12 in a hinge assembly 30 on a flat wall surface 28. This configuration is also depicted in the top, cross-sectional view of FIG. 11 and depicts the axial continuous passage 12 into which the combined hinge pin and hanging device 30 is inserted as shown in FIG. 15.

The combined hinge pin and hanging device 30 includes a first member 32. The first member 32 is elongated, straight, generally cylindrical, and of a predetermined length. The first member 32 is of a predetermined length such that it is configured for placement within a hinge assembly 10.

The first member 32 consists of a continuous first diameter for the predetermined length. As such, the first member 32 is suitable for placement securely within an axial continuous passage 12 formed collectively within first knuckles 22 of a first hinge leaf 14 and second knuckles 20 of a second hinge leaf 16. The second hinge leaf 16 is interleaved with the first hinge leaf 14, thereby to secure the first hinge leaf 14 and the second hinge leaf 16 one to another as a hinge pin.

The combined hinge pin and hanging device 30 includes a second member 34. Second member 34 (34A and 34B is various embodiments) is elongated, generally cylindrical, and not continuously straight. Second member 34 consists of a second diameter. The second member 34 and the first member 32 coupled one to another. The second member 34 extends upwardly from a top of the first member 32. The second member 34 also consisting of at least one portion that extends outwardly away from an axial line of the first member 32 upon which to hang an item.

The combined hinge pin and hanging device 30 includes a stop 38. The stop 38 is defined between the first member 32 and the second member 34 to prevent the combined hinge pin and hanging device 30 from entry beyond the stop 38 into the axial continuous passage 12 formed collectively within first knuckles 22 of a first hinge leaf 14 and second knuckles 20 of a second hinge leaf 16. An underside of the stop 38 is to rest upon a top surface of an uppermost hinge knuckle, insertion of which is depicted in FIG. 15.

In at least one embodiment, the combined hinge pin and hanging device 30 also includes a curve defined within the second member 34 to position a distal end of the second member 34 away from a mount surface upon which the first hinge leaf 14 and the second hinge leaf 16 are mounted.

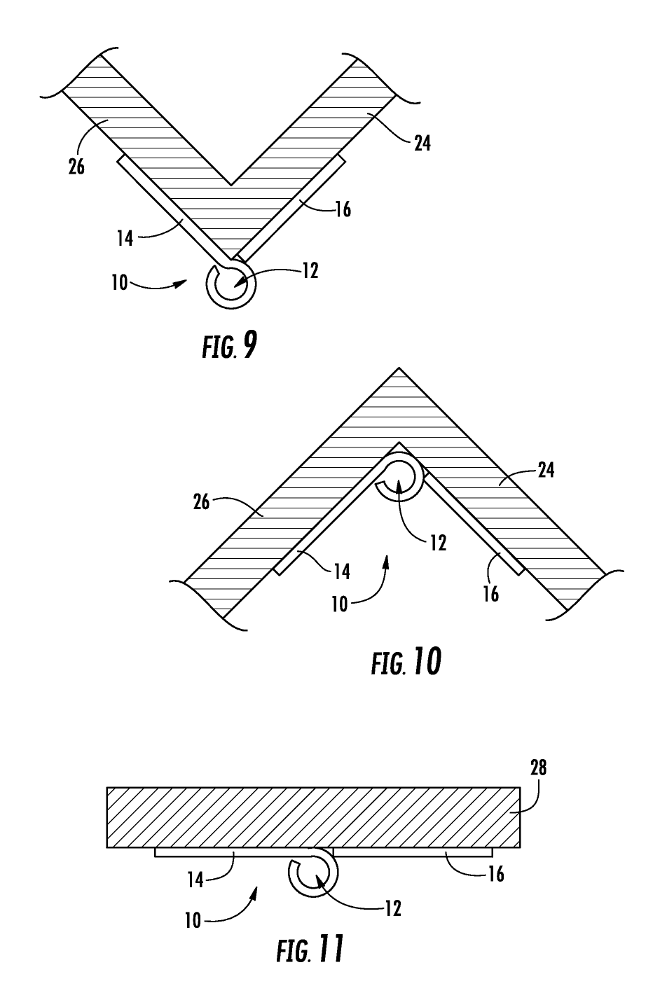

In at least one embodiment, the combined hinge pin and hanging device 30 further includes a hook integrally formed with the second member 34 and at a distal end of the combined hinge pin and hanging device 30. The hook is utilized for placement of an item to be suspended. By way of example, the suspended item 40, which in this case is plant 46 in pot 48 is suspended from the hook with chain 44 and eyelet 42 in FIG. 8.

In at least one embodiment, the combined hinge pin and hanging device 30 also includes a recess formed within the hook to receive an item suspended and hold it securely within the hook. FIG. 8 depicts a hanging plant hung from the recess in the hook of the second member 34.

In at least one embodiment of the combined hinge pin and hanging device 30, the second diameter of the second member 34A is greater than the first diameter of the first member 32. This configuration is depicted specifically in FIG. 12. Once inserted into a hinge assembly 10, the stop 38 rests upon a top surface of an uppermost hinge knuckle.

In at least one embodiment of the combined hinge pin and hanging device 30, the second diameter of the second member 34B is the same as the first diameter of the first member 32. This configuration is depicted specifically in FIG. 13. The stop 38 in this embodiment having flanges 36 and defined between the first member and the second member having a diameter greater than both of the first member 32 and second member 34B.

In at least one embodiment of the combined hinge pin and hanging device 30, the first member 32, the second member 34, and the stop 38 are integrally formed. By way of example, the combined hinge pin and hanging device 30 can be made of a single continuous piece of metal. By way of example, the combined hinge pin and hanging device 30 can be made of injection molded plastic.

In at least one embodiment of the combined hinge pin and hanging device 30, the first member 32 and the second member 34 are metal.

In at least one embodiment of the combined hinge pin and hanging device 30, the first member 32 and the second member 34 are plastic.

In at least one embodiment of the combined hinge pin and hanging device 30, the first member 32 and is metal and the second member is plastic 34.

In another exemplary embodiment, the technology described herein provides a hinge-based hanging system hanging items on walls, at inside corners between walls, at outside corners of adjacent walls, and on flat wall surfaces. The hinge-based hanging system 10, 30 includes: a first hinge leaf 14; a second hinge leaf 12; a plurality of first knuckles 22 disposed upon the first hinge leaf 14; a plurality of second knuckles 20 disposed upon the second hinge leaf 16; an axial continuous passage 12 formed collectively within the first knuckles 22 of the first hinge leaf 14 and the second knuckles 20 of the second hinge leaf 16, the second hinge leaf 16 interleaved with the first hinge leaf 14; and a combined hinge pin and hanging bracket 30 comprising: a first member 32, elongated, straight, generally cylindrical, and of a predetermined length, and consisting of a continuous first diameter for the predetermined length, for placement securely within an axial continuous passage 12 formed collectively within first knuckles 22 of a first hinge leaf 14 and second knuckles 20 of a second hinge leaf 16, the second hinge leaf 16 interleaved with the first hinge leaf 14, thereby to secure the first hinge leaf 14 and the second hinge leaf 16 one to another as a hinge pin; a second member 34, elongated, generally cylindrical, and not continuously straight, and consisting of a second diameter, the second member 34 and the first member 32 coupled one to another and the second member 34 extending upwardly from a top of the first member 32, the second member 34 also consisting of at least one portion that extends outwardly away from an axial line of the first member 32 upon which to hang an item; and a stop 38 defined between the first member 32 and the second member 34 to prevent the combined hinge pin and hanging device 30 from entry beyond the stop 38 into the axial continuous passage 12 formed collectively within first knuckles 22 of a first hinge leaf 14 and second knuckles 20 of a second hinge leaf 16, the stop 38 to rest upon a top surface of an uppermost hinge knuckle.

In at least one embodiment, the hinge-based hanging system 10 also includes: a plurality of first recessed apertures 40 defined with the first hinge leaf 14; a plurality of second recessed apertures 40 defined with the second hinge leaf 16; and a plurality of mounting screws 42 to thread through the plurality of first recessed apertures 40 and the plurality of second recessed apertures 40 to secure the first hinge leaf 14 and the second hinge leaf 16 to one of an inside corner between walls, an outside corner of adjacent walls, and a flat wall surface. The apertures 40 can vary in size and placement for each hinge assembly product.

In at least one embodiment, the hinge-based hanging system 10 further includes a plurality of decorative caps 18 to cover the first recessed apertures 40 and the plurality of second recessed apertures 40 once the mounting screws 42 are inserted and the system is mounted.

In at least one embodiment of the hinge-based hanging system, the first hinge leaf 14 and the second hinge leaf 16 collectively form a circular shape. By way of example, this configuration is depicted in FIG. 3.

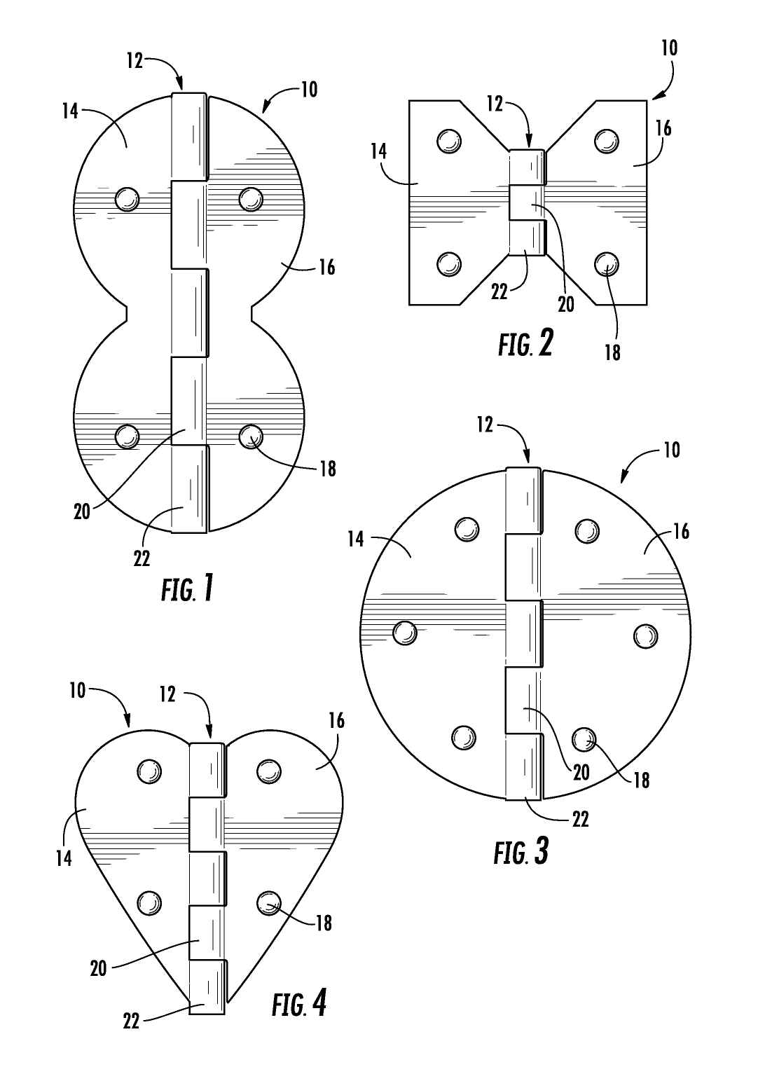

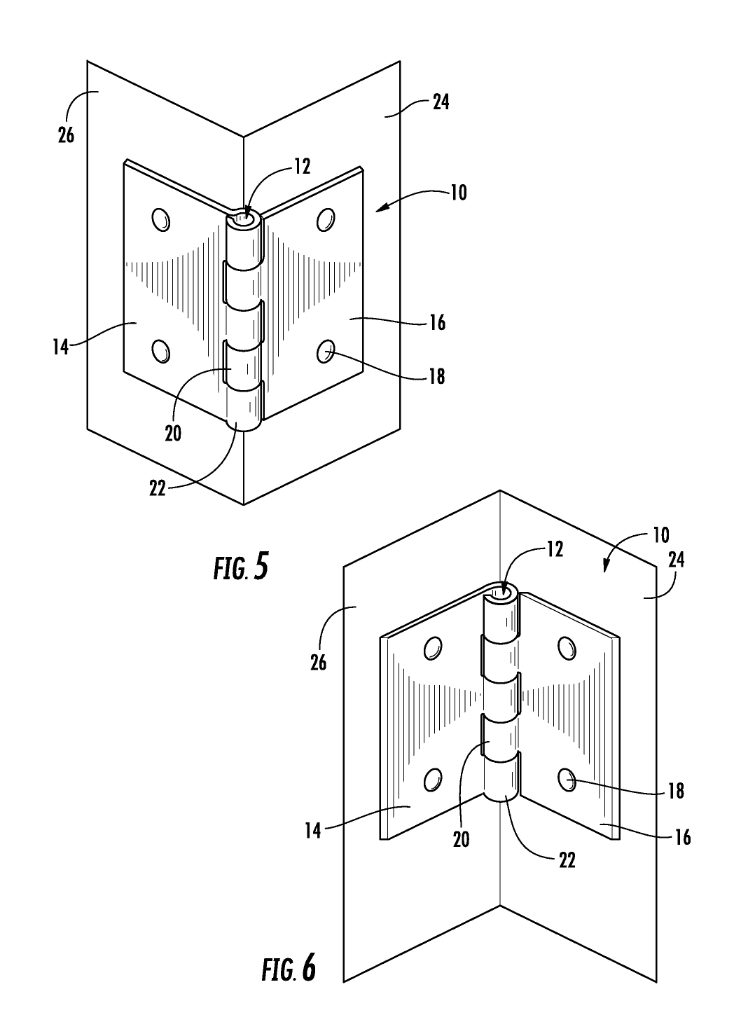

In at least one embodiment of the hinge-based hanging system 10, the first hinge leaf 14 and the second hinge 16 leaf collectively form a decorative, non-square shape. A dual circle, or guitar-like pattern in depicted in FIG. 1. A butterfly pattern is depicted in FIG. 2. A heart pattern is depicted in FIG. 4. Additionally, in at least one embodiment, the first hinge 14 and the second hinge lead 16 form a pattern that is not symmetric.

In at least one embodiment, the hinge-based hanging system also includes a curve defined within the second member 34 of the combined hinge pin and hanging bracket 30 to position a distal end of the second member 34 away from a mount surface upon which the first hinge leaf 14 and the second hinge leaf 16 are mounted.

In at least one embodiment, the hinge-based hanging system further includes a hook integrally formed with the second member 34 of the combined hinge pin and hanging bracket 30 and at a distal end of the of the combined hinge pin and hanging bracket 30.

In at least one embodiment, the hinge-based hanging system also includes a recess formed within the hook to receive an item suspended and hold it securely within the hook.

In at least one embodiment, the hinge-based hanging system further includes a hanging link 42 to hang upon the hook and with which to couple to an item to be suspended.

In yet another exemplary embodiment, the technology described herein provides a first member 32, elongated, straight, generally cylindrical, and of a predetermined length, and consisting of a continuous first diameter for the predetermined length, for placement securely within an axial continuous passage 12 formed collectively within first knuckles 22 of a first hinge leaf 14 and second knuckles of a second hinge leaf 16, the second hinge leaf 16 interleaved with the first hinge leaf 14, thereby to secure the first hinge leaf 14 and the second hinge leaf 16 one to another as a hinge pin; a second member 34, elongated, generally cylindrical, and not continuously straight, and consisting of a second diameter, the second member 34 and the first member 32 coupled one to another and the second member 34 extending upwardly from a top of the first member 32, the second member 34 also consisting of at least one portion that extends outwardly away from an axial line of the first member 32 upon which to hang an item; a stop 38 defined between the first member 32 and the second member 34 to prevent the combined hinge pin and hanging device 30 from entry beyond the stop 38 into the axial continuous passage 12 formed collectively within first knuckles 22 of a first hinge leaf 14 and second knuckles 20 of a second hinge leaf 16, the stop 38 to rest upon a top surface of an uppermost hinge knuckle; a curve defined within the second member 34 to position a distal end of the second member 34 away from a mount surface upon which the first hinge leaf 14 and the second hinge leaf 16 are mounted; and a hook integrally formed with the second member 34 and at a distal end of the combined hinge pin and hanging device 30.

In various applications, the hinge-based hanging system provides a novel means by which to suspend plants, mobiles, swag, decorations, and so forth. Additionally, the hinge-based hanging system provides a novel placement means by allowing for mounting with inside corners, outsides corners, and on flat wall surfaces. Additionally, the hinge-based hanging system can be utilized on inside corners and outside corners wherein the walls are not necessarily at a ninety degree angle relative to one another.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. A combined hinge pin and hanging device, for hanging items selectively on walls at inside corners between walls, at outside corners of adjacent walls, and on flat wall surfaces, the device comprising:
a first member, elongated, straight, generally cylindrical, and of a predetermined length, and consisting of a continuous first diameter for the predetermined length, for placement securely within an axial continuous passage formed collectively within first knuckles of a first hinge leaf and second knuckles of a second hinge leaf, the second hinge leaf interleaved with the first hinge leaf, thereby to secure the first hinge leaf and the second hinge leaf one to another as a hinge pin;
a second member, elongated, generally cylindrical, and not continuously straight, and consisting of a second diameter, the second member and the first member coupled one to another and the second member extending upwardly from a top of the first member, the second member also consisting of at least one portion that extends outwardly away from an axial line of the first member upon which to hang an item; and
a stop defined between the first member and the second member to prevent the combined hinge pin and hanging device from entry beyond the stop into the axial continuous passage formed collectively within first knuckles of a first hinge leaf and second knuckles of a second hinge leaf, the stop to rest upon a top surface of an uppermost hinge knuckle.

2. The combined hinge pin and hanging device of claim 1, further comprising:
a curve defined within the second member to position a distal end of the second member away from a mount surface upon which the first hinge leaf and the second hinge leaf are mounted.

3. The combined hinge pin and hanging device of claim 1, further comprising:
a hook integrally formed with the second member and at a distal end of the combined hinge pin and hanging device.

4. The combined hinge pin and hanging device of claim 3, further comprising:
a recess formed within the hook to receive an item suspended and hold it securely within the hook.

5. The combined hinge pin and hanging device of claim 1, wherein the second diameter of the second member is greater than the first diameter of the first member.

6. The combined hinge pin and hanging device of claim 1, wherein the second diameter of the second member is the same as the first diameter of the first member, the stop defined between the first member and the second member having a diameter greater than both of the first member and second member.

7. The combined hinge pin and hanging device of claim 1, wherein the first member, the second member, and the stop are integrally formed.

8. The combined hinge pin and hanging device of claim 1, wherein the first member and the second member are metal.

9. The combined hinge pin and hanging device of claim 1, wherein the first member and the second member are plastic.

10. The combined hinge pin and hanging device of claim 1, wherein the first member and is metal and the second member is plastic.

11. A hinge-based hanging system hanging items on walls, at inside corners between walls, at outside corners of adjacent walls, and on flat wall surfaces, the hinge-based hanging system comprising:
a first hinge leaf;
a second hinge leaf;
a plurality of first knuckles disposed upon the first hinge leaf;
a plurality of second knuckles disposed upon the second hinge leaf;
an axial continuous passage formed collectively within the first knuckles of the first hinge leaf and the second knuckles of the second hinge leaf, the second hinge leaf interleaved with the first hinge leaf; and
a combined hinge pin and hanging bracket comprising:
a first member, elongated, straight, generally cylindrical, and of a predetermined length, and consisting of a continuous first diameter for the predetermined length, for placement securely within an axial continuous passage formed collectively within first knuckles of a first hinge leaf and second knuckles of a second hinge leaf, the second hinge leaf interleaved with the first hinge leaf, thereby to secure the first hinge leaf and the second hinge leaf one to another as a hinge pin;
a second member, elongated, generally cylindrical, and not continuously straight, and consisting of a second diameter, the second member and the first member coupled one to another and the second member extending upwardly from a top of the first member, the second member also consisting of at least one portion that extends outwardly away from an axial line of the first member upon which to hang an item; and
a stop defined between the first member and the second member to prevent the combined hinge pin and hanging device from entry beyond the stop into the axial continuous passage formed collectively within first knuckles of a first hinge leaf and second knuckles of a second hinge leaf, the stop to rest upon a top surface of an uppermost hinge knuckle.

12. The hinge-based hanging system of claim 11, further comprising:
a plurality of first recessed apertures defined with the first hinge leaf;
a plurality of second recessed apertures defined with the second hinge leaf; and
a plurality of mounting screws to thread through the plurality of first recessed apertures and the plurality of second recessed apertures to secure the first hinge leaf and the second hinge leaf to one of an inside corner between walls, an outside corner of adjacent walls, and a flat wall surface.

13. The hinge-based hanging system of claim 12, further comprising:
a plurality of decorative caps to cover the first recessed apertures and the plurality of second recessed apertures once the mounting screws are inserted and the system is mounted.

14. The hinge-based hanging system of claim 11, wherein the first hinge leaf and the second hinge leaf collectively form a circular shape.

15. The hinge-based hanging system of claim 11, wherein the first hinge leaf and the second hinge leaf collectively form a decorative, non-square shape.

16. The hinge-based hanging system of claim 11, further comprising:
a curve defined within the second member of the combined hinge pin and hanging bracket to position a distal end of the second member away from a mount surface upon which the first hinge leaf and the second hinge leaf are mounted.

17. The hinge-based hanging system of claim 11, further comprising:
a hook integrally formed with the second member of the combined hinge pin and hanging bracket and at a distal end of the of the combined hinge pin and hanging bracket.

18. The hinge-based hanging system of claim 17, further comprising:
a recess formed within the hook to receive an item hanged and hold it securely within the hook.

19. The hinge-based hanging system of claim 17, further comprising:
a hanging link to hang upon the hook and with which to couple to an item to be suspended.

20. A combined hinge pin and hanging device comprising:
a first member, elongated, straight, generally cylindrical, and of a predetermined length, and consisting of a continuous first diameter for the predetermined length, for placement securely within an axial continuous passage formed collectively within first knuckles of a first hinge leaf and second knuckles of a second hinge leaf, the second hinge leaf interleaved with the first hinge leaf, thereby to secure the first hinge leaf and the second hinge leaf one to another as a hinge pin;
a second member, elongated, generally cylindrical, and not continuously straight, and consisting of a second diameter, the second member and the first member coupled one to another and the second member extending upwardly from a top of the first member, the second member also consisting of at least one portion that extends outwardly away from an axial line of the first member upon which to hang an item;
a stop defined between the first member and the second member to prevent the combined hinge pin and hanging device from entry beyond the stop into the axial continuous passage formed collectively within first knuckles of a first hinge leaf and second knuckles of a second hinge leaf, the stop to rest upon a top surface of an uppermost hinge knuckle;
a curve defined within the second member to position a distal end of the second member away from a mount surface upon which the first hinge leaf and the second hinge leaf are mounted; and
a hook integrally formed with the second member and at a distal end of the combined hinge pin and hanging device.
